(19) United States
(12) Patent Application Publication
(10) Pub. No.: US 2021/0147038 A1
(43) Pub. Date: May 20, 2021

(54) METHOD AND SYSTEM FOR AUTOMATING CARGO SHIPMENT PLANNING FOR RO-RO SHIP

(71) Applicant: Pusan National University Industry-University Cooperation Foundation, Busan (KR)

(72) Inventors: Kwang-Ryel RYU, Busan (KR); Taekwang KIM, Busan (KR)

(21) Appl. No.: 16/949,580

(22) Filed: Nov. 4, 2020

(30) Foreign Application Priority Data
Nov. 20, 2019 (KR) 10-2019-0149466
Mar. 6, 2020 (KR) 10-2020-0028460

(51) Int. Cl. B63B 25/00; B63B 25/28; G06Q 10/04; G06Q 10/08; B63B 49/00

(52) U.S. Cl. CPC B63B 25/008; B63B 25/28; B63B 49/00; G06Q 10/083; G06Q 10/04

(57) ABSTRACT

Disclosed are a method and system for automating cargo shipment planning for a roll-on/roll-off (ro-ro) ship. The system may include a route search unit configured to compute a shipment route of a cargo using a cargo arrangement plan, a slot management unit configured to manage a shipment route along which a cargo of each slot indicative of a loading point in the cargo arrangement plan can be reached and to generate an optimum list of cargo loading target slots, and a shipment determination unit configured to receive the optimum list of cargo loading target slots from the slot management unit and to output information on whether to ship the cargo and a shipment position with reference to the optimum list of cargo loading target slots when the cargo to be shipped is input.

### CROSS REFERENCE TO RELATED APPLICATION

This application claims priority under 35 U.S.C. § 119 to Korean Patent Application No. 10-2020-0028460 filed on Mar. 06, 2020, and Korean Patent Application No. 10-2019-0149466, filed Nov. 20, 2019, all of which are incorporated herein by reference in their entirety.

### BACKGROUND OF THE INVENTION

### Technical Field

The following embodiments relate to a method and system for automating cargo shipment planning for a roll-on/roll-off (ro-ro) ship. This research was supported by the Ministry of Science and ICT (MSIT), Korea, under the Grand Information Technology Research Center support program (IITP-2020-2016-0-00318) supervised by the Institute for Information & communications Technology Planning & Evaluation (IITP).

### Description of the Related Art

A roll-on/roll-off (ro-ro) ship is a cargo ship that transports a truck or a trailer or a common vehicle onto which a cargo is loaded, and is a ship in which a cargo can be directly loaded or unloaded by its self-power without using a separate crane.

A ro-ro ship cargo is basically divided into an automation cargo and a fixed cargo. The automation cargo is a cargo which may be shipped by its self-power. A cargo, such as a vehicle or a truck, corresponds to the automation cargo. In contrast, the fixed cargo is a cargo that must be shipped using equipment, such as a forklift, because the cargo cannot be shipped by its self-power.

Korean Patent Application Publication No. 10-2018-0089953 relates to an optimal cargo loading planning method and system for a ro-ro ship vessel, and describes a technology related to a system for determining the loading sequence and position of a ro-ro ship, which can maximize a total loading quantity.

### SUMMARY OF THE INVENTION

Embodiments describe a method and system for automating cargo shipment planning for a ro-ro ship, and more particularly, provide a technology for determining whether to ship a cargo and a shipment position so that a re-handling task does not occur.

Embodiments provide a method and system for automating cargo shipment planning for a ro-ro ship, which can reduce shipment expenses by carefully determining a loading position in order to reduce the shipment waiting time of a cargo while preventing a re-handling task from occurring as much as possible, in such a manner that when the cargo to be shipped enters a harbor, a loading position where a re-handling task does not occur is determined and the waiting of the cargo is proposed if such a position is not present.

In an aspect, a system for automating cargo shipment planning for a roll-on/roll-off (ro-ro) ship may include a route search unit configured to compute a shipment route of a cargo using a cargo arrangement plan, a slot management unit configured to manage a shipment route along which a cargo of each slot indicative of a loading point in the cargo arrangement plan can be reached and to generate an optimum list of cargo loading target slots, and a shipment determination unit configured to receive the optimum list of cargo loading target slots from the slot management unit and to output information on whether to ship the cargo and a shipment position with reference to the optimum list of cargo loading target slots when the cargo to be shipped is input.

The route search unit may be configured to generate a route graph from the cargo arrangement plan in order to compute the shipment route of the cargo. The route graph may be configured by generating peaks at the entry point of a ship and the loading point of the cargo and generating trunk lines between peaks along which the cargo is movable.

The slot management unit may be configured to update the shipment route along which the cargo of each slot is reachable if a loading situation of the cargo is changed.

The slot management unit may be configured to generate the optimum list of cargo loading target slots by computing a list of slots where a re-handling task does not occur although a cargo is loaded in a current situation and to update the optimum list of cargo loading target slots whenever a loading situation is changed.

The shipment determination unit may be configured to receive the optimum list of cargo loading target slots from the slot management unit, output results whenever a cargo requests whether to ship the cargo and a shipment position, and have the requested cargo to wait if a target loading slot for the requested cargo is not present in the list.

In an aspect, a method of automating cargo shipment planning for a roll-on/roll-off (ro-ro) ship through a system for automating cargo shipment planning for a ro-ro ship may include computing a shipment route of a cargo using a cargo arrangement plan, managing a shipment route along which a cargo of each slot indicative of a loading point in the cargo arrangement plan can be reached and generating an optimum list of cargo loading target slots, and receiving the optimum list of cargo loading target slots and outputting information on whether to ship the cargo and a shipment position with reference to the optimum list of cargo loading target slots when the cargo to be shipped is input.

Computing the shipment route of the cargo using the cargo arrangement plan may include generating a route graph from the cargo arrangement plan in order to compute the shipment route of the cargo. The route graph may be configured by generating peaks at the entry point of a ship and the loading point of the cargo and generating trunk lines between peaks along which the cargo is movable.

Generating the optimum list of cargo loading target slots may include updating the shipment route along which the cargo of each slot is reachable if a loading situation of the cargo is changed.

Generating the optimum list of cargo loading target slots may include generating the optimum list of cargo loading target slots by computing a list of slots where a re-handling task does not occur although a cargo is loaded in a current situation, and updating the optimum list of cargo loading target slots whenever a loading situation is changed.

Outputting the information on whether to ship the cargo and the shipment position with reference to the optimum list of cargo loading target slots may include receiving the optimum list of cargo loading target slots, outputting results whenever a cargo requests whether to ship the cargo and a shipment position, and having the requested cargo to wait if a target loading slot for the requested cargo is not present in the list.

### BRIEF DESCRIPTION OF THE DRAWINGS

FIG. 1 is a diagram illustrating a common ro-ro ship cargo arrangement plan.

FIG. 2 is a block diagram illustrating a configuration of a system for automating cargo shipment planning for a ro-ro ship according to an embodiment.

FIG. 3 is a flowchart illustrating a method of automating cargo shipment planning for a ro-ro ship according to an embodiment.

FIG. 4 is a diagram illustrating the shipment route of a cargo trajectory according to an embodiment.

FIGS. 5A to FIG. 5E are diagrams illustrating a change in an optimum list of cargo loading target slots during a shipment task according to an embodiment.

### DETAILED DESCRIPTION

Hereinafter, embodiments are described in detail with reference to the accompanying drawings. However, the described embodiments may be modified in various other forms, and the scope of the present disclosure is not restricted by the following embodiments. Furthermore, various embodiments are provided to more fully describe the present disclosure to a person having average knowledge in the art. The shapes, sizes, etc. of elements in the drawings may be exaggerated for a clear description.

The following embodiments relate to a technology for automating cargo shipment planning for a ro-ro ship, and may provide a technology for efficiently shipping a cargo by determining a loading position where a re-handling task does not occur when the cargo to be shipped enters a harbor and proposing the waiting of the cargo if such a position is not present.

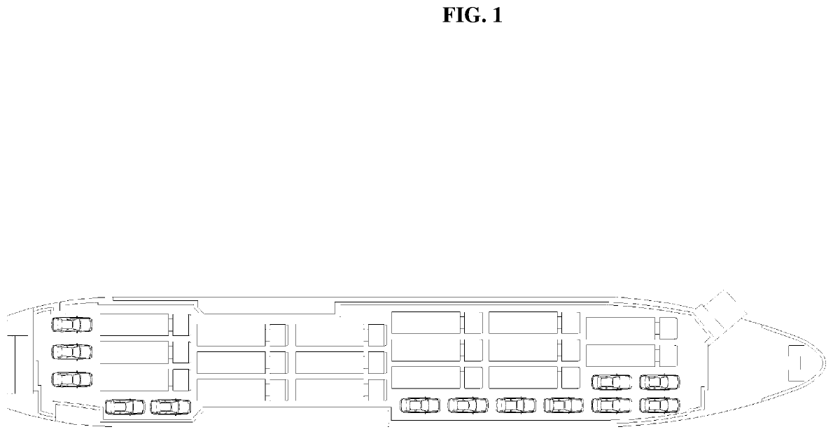

FIG. 1 is a diagram illustrating a common ro-ro ship cargo arrangement plan.

A cargo for a ro-ro ship is shipped according to a previously planned cargo arrangement plan. As illustrated in FIG. 1, the cargo arrangement plan designates shipment positions depending on the type of cargo. The cargo arrangement plan is approved by an institution by reviewing stability and loading efficiency of a ship when a cargo is shipped. Various types of cargo arrangement plans are present on the spot. Among them, an arrangement plan by which reserved cargos can be most loaded may be selected and used.

When a reserved cargo enters a harbor, site personnel check a cargo arrangement plan and designate a shipment position. The corresponding cargo is moved and loaded at the designated position. In this case, the site personnel may carefully determine a loading position in order to reduce the shipment waiting time of the cargo while preventing a re-handling task from occurring as much as possible.

The re-handling task is a task for moving a previously loaded cargo to another position so that a cargo to be now loaded is shipped if the cargo to be now loaded cannot be shipped due to the previously loaded cargo. If such a task is increased, a shipment time is increased. Accordingly, the number of re-handling tasks must be reduced as much as possible because shipment expenses are increased.

The shipment waiting time of a cargo is the time taken for the cargo to wait at a harbor before shipment. If there is a good possibility that a re-handling task may subsequently occur when a cargo is now shipped, site personnel may have the cargo wait. Furthermore, shipment expenses can be reduced by reducing a cargo shipment waiting time as much as possible because a shipment time is increased as the cargo shipment waiting time is increased.

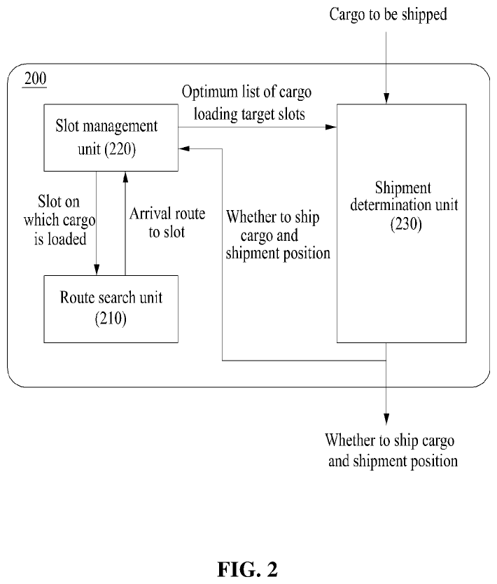

FIG. 2 is a block diagram illustrating a configuration of a system 200 for automating cargo shipment planning for a ro-ro ship according to an embodiment.

Referring to FIG. 2, the system 200 for automating cargo shipment planning for a ro-ro ship according to an embodiment may include a route search unit 210, a slot management unit 220 and a shipment determination unit 230.

The route search unit 210 may compute a shipment route of a cargo using a cargo arrangement plan. The route search unit 210 has a route graph previously generated using the cargo arrangement plan, and may compute the shipment route of the cargo using the cargo arrangement plan.

More specifically, the route search unit 210 may generate the route graph from the cargo arrangement plan in order to compute the shipment route of the cargo. The route graph may be configured by generating peaks at the entry point of a ship and the loading point of the cargo and generating a trunk line between peaks along which the cargo may move.

The slot management unit 220 may manage a shipment route along which the cargo of each slot indicative of a loading point in the cargo arrangement plan may be reached, and may generate an optimum list of cargo loading target slots. The slot denotes a loading point in the cargo arrangement plan. In this case, if a loading situation of the cargo is changed, the slot management unit 220 may update the shipment route along which the cargo of each slot may be reached.

Furthermore, the slot management unit 220 may generate an optimum list of cargo loading target slots by computing a list of slots where a re-handling task does not occur although the cargo is loaded in a current situation, and may update the optimum list of cargo loading target slots whenever the loading situation is changed.

The shipment determination unit 230 may receive the optimum list of cargo loading target slots from the slot management unit, and may output information on whether to ship the cargo and a shipment position with reference to the optimum list of cargo loading target slots if the cargo to be shipped is input.

More specifically, the shipment determination unit 230 may receive the optimum list of cargo loading target slots from the slot management unit 220, may store the received optimum list of cargo loading target slots, may output results whenever a cargo requests whether to ship the cargo and a shipment position, and may have the requested cargo to wait if a target loading slot for the requested cargo is not present in the list.

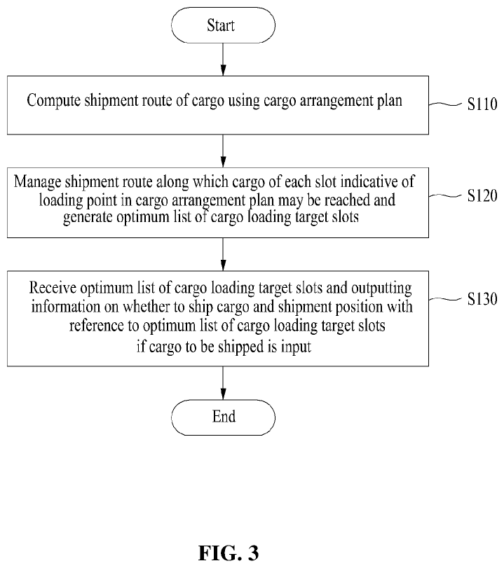

FIG. 3 is a flowchart illustrating a method of automating cargo shipment planning for a ro-ro ship according to an embodiment.

Referring to FIG. 3, the method of automating cargo shipment planning through the system for automating cargo shipment planning for a ro-ro ship according to an embodiment may include step S110 of computing a shipment route of a cargo using a cargo arrangement plan, step S120 of managing a shipment route along which the cargo of each slot indicative of a loading point in the cargo arrangement plan may be reached, and generating an optimum list of cargo loading target slots, and step S130 of receiving the optimum list of cargo loading target slots and outputting information on whether to ship the cargo and a shipment position with reference to the optimum list of cargo loading target slots if the cargo to be shipped is input.

The steps of the method of automating cargo shipment planning for a ro-ro ship according to an embodiment are described below.

The method of automating cargo shipment planning for a ro-ro ship according to an embodiment may be more specifically described by taking the system for automating cargo shipment planning for a ro-ro ship according to an embodiment, described with reference to FIG. 2, as an example. The system for automating cargo shipment planning for a ro-ro ship according to an embodiment may include the route search unit, the slot management unit, and the shipment determination unit.

At step S110, the route search unit 210 may compute the shipment route of a cargo using a cargo arrangement plan. The route search unit 210 has a route graph previously generated using the cargo arrangement plan, and may compute the shipment route of the cargo using the cargo arrangement plan.

At step S120, the slot management unit 220 may manage a shipment route along which the cargo of each slot indicative of a loading point in the cargo arrangement plan may be reached, and may generate an optimum list of cargo loading target slots. In this case, if the loading situation of the cargo is changed, the slot management unit 220 may update the shipment route along which the cargo of each slot may be reached.

Furthermore, the slot management unit 220 may generate an optimum list of cargo loading target slots by computing a list of slots where a re-handling task does not occur although a cargo is loaded in a current situation, and may update the optimum list of cargo loading target slots whenever the loading situation is changed.

At step S130, the shipment determination unit 230 may receive the optimum list of cargo loading target slots from the slot management unit, and may output information on whether to ship the cargo and a shipment position with reference to the optimum list of cargo loading target slots when the cargo to be shipped is input.

More specifically, the shipment determination unit 230 may receive the optimum list of cargo loading target slots from the slot management unit 220, may store the received optimum list, may output results whenever a cargo requests whether to ship the cargo and a shipment position, and may have the requested cargo to wait if a target loading slot for the requested cargo is not present in the list.

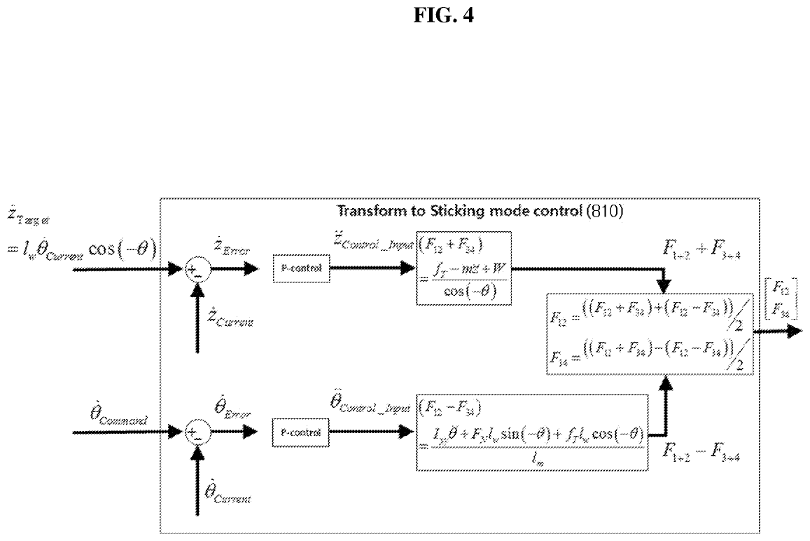

FIG. 4 is a diagram illustrating the shipment route of a cargo trajectory according to an embodiment.

The route search unit may generate a route graph from a cargo arrangement plan in order to compute the shipment route of a cargo.

For example, the route graph may be configured with peaks and trunk lines. The route search unit may generate peaks at the ship entry point and the loading point of a cargo, and may generate a route graph by generating and connecting trunk lines between peaks along which the cargo may move.

Whether a cargo is movable is determined by taking the rotation radius of the cargo into consideration. It is assumed that a movement trajectory of the cargo follows a curve in the cargo arrangement plan. As illustrated in FIG. 4, each trunk line stores a computed movement trajectory figure. If a cargo is loaded onto any slot, a trunk line overlapping a corresponding slot may be deleted. Accordingly, a subsequent shipment route 410 of the cargo may be computed to avoid the slot onto which the cargo is loaded.

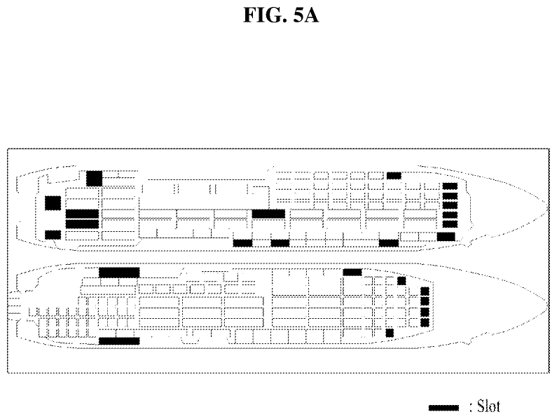

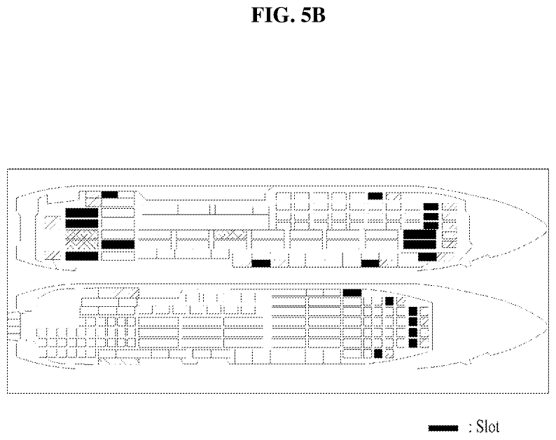

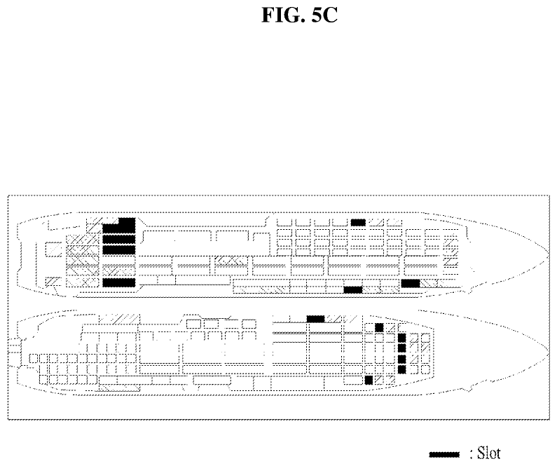

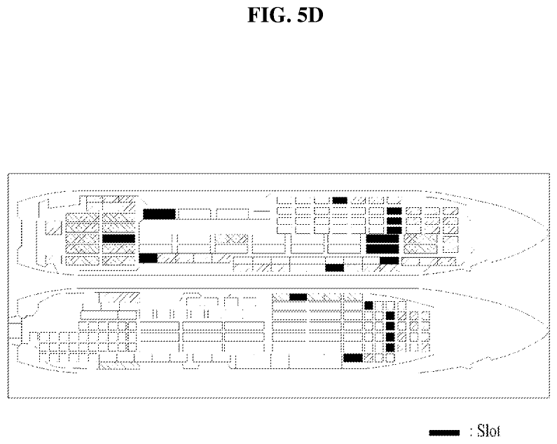

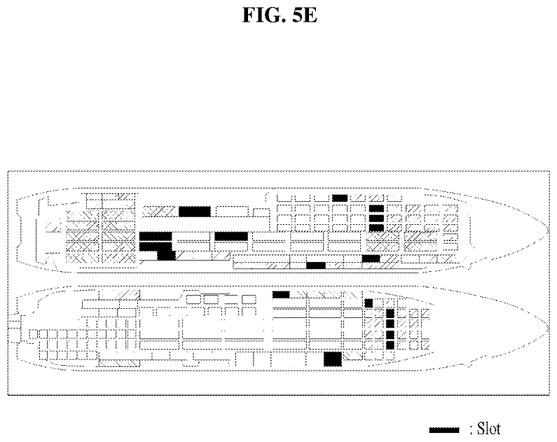

FIGS. 5A to 5E are diagrams illustrating a change in an optimum list of cargo loading target slots during a shipment task according to an embodiment.

Referring to FIGS. 5A to 5E, the slot management unit may manage information, which is changed according to a slot situation varying as the system for automating cargo shipment planning for a ro-ro ship according to an embodiment operates. Each of slots has a route along which a cargo reaches a corresponding slot, and information such as a list of other slots whose routes need to be changed as cargos are loaded.

As described above, the slot management unit has a shipment route along which a cargo may be reached for each slot, and may update the shipment route whenever a loading situation is changed. Furthermore, the slot management unit has a list of slots in which a re-handling task does not occur although a cargo is loaded in a current situation, and may also update the list of slots whenever a loading situation is changed.

More specifically, when a cargo is loaded onto a slot, the slot management unit may update the route of another slot that needs to be updated by requesting the update from the route search unit, and thus can maintain the latest slot information.

Furthermore, the slot management unit may compute a list of slots in which a re-handling task does not occur when a cargo is loaded using such slot information. The list of slots is computed by configuring a “list of other slots whose routes need to be changed as a cargo is loaded onto a corresponding slot.” The reason for this is that although the cargo is loaded onto the corresponding slot, the presence of a shipment route to all of other slots is guaranteed. The list of slots is called an optimum list of cargo loading target slots. The list of slots recorded as a shipment task is actually performed may be indicated in order as illustrated in FIGS. 5A to 5E.

Furthermore, the shipment determination unit may receive the latest optimum list of cargo loading target slots from the slot management unit, may store the received latest optimum list, and may output results whenever a cargo requests whether to ship the cargo and a shipment position. The shipment determination unit may propose to have a requested cargo to wait if a slot onto which the requested cargo will be loaded is not present in the list.

The aforementioned apparatus (or device) may be implemented as a hardware component, a software component and/or a combination of them. For example, the apparatus and elements described in the embodiments may be implemented using one or more general-purpose computers or special-purpose computers, for example, a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processing apparatus (or processor) may perform an operating system (OS) and one or more software applications executed on the OS. Furthermore, the processing apparatus may access, store, manipulate, process and generate data in response to the execution of software. For convenience of understanding, one processing apparatus has been illustrated as being used, but a person having ordinary skill in the art may understand that the processing apparatus may include a plurality of processing elements and/or a plurality of types of processing elements. For example, the processing apparatus may include a plurality of processors or a single processor and a single controller. Furthermore, other processing configurations, such as a parallel processor, are also possible.

Software may include a computer program, code, an instruction or a combination of one or more of them and may configure a processor so that it operates as desired or may instruct processors independently or collectively. The software and/or data may be embodied in any type of a machine, component, physical device, virtual equipment, or computer storage medium or device so as to be interpreted by the processor or to provide an instruction or data to the processor. The software may be distributed to computer systems connected over a network and may be stored or executed in a distributed manner. The software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure alone or in combination. The program instructions stored in the medium may be specially designed and constructed for the present disclosure, or may be known and available to those skilled in the field of computer software. Examples of the computer-readable storage medium include magnetic media such as a hard disk, a floppy disk and a magnetic tape, optical media such as a CD-ROM and a DVD, magneto-optical media such as a floptical disk, and hardware devices specially configured to store and execute program instructions such as a ROM, a RAM, and a flash memory. Examples of the program instructions include not only machine language code that is constructed by a compiler but also high-level language code that can be executed by a computer using an interpreter or the like.

According to embodiments, there can be provided the method and system for automating cargo shipment planning for a ro-ro ship, wherein when a cargo to be shipped enters a harbor, a loading position where a re-handling task does not occur is determined and the waiting of the cargo is proposed if such a position is not present, thereby reducing shipment expenses by carefully determining a loading position in order to reduce the shipment waiting time of the cargo while preventing a re-handling task from occurring as much as possible.

As described above, although the embodiments have been described in connection with the limited embodiments and drawings, those skilled in the art may modify and change the embodiments in various ways from the description. For example, proper results may be achieved although the above descriptions are performed in order different from that of the described method and/or the aforementioned elements, such as the system, configuration, device, and circuit, are coupled or combined in a form different from that of the described method or replaced or substituted with other elements or equivalents.

Accordingly, other implementations, other embodiments, and equivalents of the claims fall within the scope of the claims.

What is claimed is:

1. A system for automating cargo shipment planning for a roll-on/roll-off (ro-ro) ship, the system comprising:
a route search unit configured to compute a shipment route of a cargo using a cargo arrangement plan;
a slot management unit configured to manage a shipment route along which a cargo of each slot indicative of a loading point in the cargo arrangement plan is able to be reached and to generate an optimum list of cargo loading target slots; and
a shipment determination unit configured to receive the optimum list of cargo loading target slots from the slot management unit and to output information on whether to ship the cargo and a shipment position with reference to the optimum list of cargo loading target slots when the cargo to be shipped is input.

2. The system of claim 1, wherein:
the route search unit is configured to generate a route graph from the cargo arrangement plan in order to compute the shipment route of the cargo, and
the route graph is configured by generating peaks at an entry point of a ship and a loading point of the cargo and generating trunk lines between peaks along which the cargo is movable.

3. The system of claim 1, wherein the slot management unit is configured to update the shipment route along which the cargo of each slot is reachable if a loading situation of the cargo is changed.

4. The system of claim 1, wherein the slot management unit is configured to:
generate the optimum list of cargo loading target slots by computing a list of slots where a re-handling task does not occur although a cargo is loaded in a current situation, and
update the optimum list of cargo loading target slots whenever a loading situation is changed.

5. The system of claim 1, wherein the shipment determination unit is configured to:
receive the optimum list of cargo loading target slots from the slot management unit,
output results whenever a cargo requests whether to ship the cargo and a shipment position, and
have the requested cargo to wait if a target loading slot for the requested cargo is not present in the list.

6. A method of automating cargo shipment planning for a roll-on/roll-off (ro-ro) ship through a system for automating cargo shipment planning for a ro-ro ship, the method comprising:
computing a shipment route of a cargo using a cargo arrangement plan;
managing a shipment route along which a cargo of each slot indicative of a loading point in the cargo arrangement plan is able to be reached and generating an optimum list of cargo loading target slots; and
receiving the optimum list of cargo loading target slots and outputting information on whether to ship the cargo and a shipment position with reference to the optimum list of cargo loading target slots when the cargo to be shipped is input.

7. The method of claim 6, wherein:
computing the shipment route of the cargo using the cargo arrangement plan comprises generating a route graph from the cargo arrangement plan in order to compute the shipment route of the cargo, and
the route graph is configured by generating peaks at an entry point of a ship and a loading point of the cargo and generating trunk lines between peaks along which the cargo is movable.

8. The method of claim 6, wherein generating the optimum list of cargo loading target slots comprises updating the shipment route along which the cargo of each slot is reachable if a loading situation of the cargo is changed.

9. The method of claim 6, wherein generating the optimum list of cargo loading target slots comprises:
generating the optimum list of cargo loading target slots by computing a list of slots where a re-handling task does not occur although a cargo is loaded in a current situation, and
updating the optimum list of cargo loading target slots whenever a loading situation is changed.

10. The method of claim 6, wherein outputting the information on whether to ship the cargo and the shipment position with reference to the optimum list of cargo loading target slots comprises:
receiving the optimum list of cargo loading target slots,
outputting results whenever a cargo requests whether to ship the cargo and a shipment position, and
having the requested cargo to wait if a target loading slot for the requested cargo is not present in the list.
